(19) United States
(12) Patent Application Publication
(10) Pub. No.: US 2012/0314690 A1
(43) Pub. Date: Dec. 13, 2012

(54) Method and Apparatus for Performing Handover Procedure in Wireless Communication System

(76) Inventors: Jian Xu, Gyeongki-do (KR); Gene Beck Hahn, Gyeongki-do (KR); Seung June Yi, Gyeongki-do (KR)

(21) Appl. No.: 13/580,020

(22) PCT Filed: May 13, 2011
(86) PCT No.: PCT/KR2011/003554

§ 371 Date: Aug. 20, 2012

Related U.S. Application Data
(60) Provisional application No. 61/334,593, filed on May 14, 2010.

(51) Int. Cl. H04W 36/02; H04W 36/38

(52) U.S. Cl. 370/331

(57) ABSTRACT

A method and apparatus of performing a handover procedure in a wireless communication system is provided. The method includes receiving a handover request message from a relay node (RN), transmitting an end marker to the RN, buffering downlink (DL) data packets, transmitting a handover request acknowledgement message to the RN if the handover request message is acknowledged, and forwarding the buffered DL data packets to a target BS.

### TECHNICAL FIELD

The present invention relates to wireless communication, and more particularly, to a method and apparatus for performing a handover procedure in a wireless communication system.

### BACKGROUND ART

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

FIG. 1 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 1, the E-UMTS network includes an evolved UMTS terrestrial radio access network (E-UTRAN), an Evolved Packet Core (EPC) and one or more user equipment. The E-UTRAN may include one or more evolved NodeB (eNB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNB 20 to UE 10, and “uplink” refers to communication from the UE to an eNB. UE 10 refers to communication equipment carried by a user and may be also referred to as a mobile station (MS), a user terminal (UT), a subscriber station (SS) or a wireless device.

An eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signalling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

FIG. 2 is a block diagram depicting architecture of a typical E-UTRAN and a typical EPC. As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

FIG. 3 is block diagram depicting the user-plane protocol and the control-plane protocol stack for the E-UMTS. FIG. 3(a) is block diagram depicting the user-plane protocol, and FIG. 3(b) is block diagram depicting the control-plane protocol. As illustrated, the protocol layers may be divided into a first layer (L1), a second layer (L2) and a third layer (L3) based upon the three lower layers of an open system interconnection (OSI) standard model that is well known in the art of communication systems.

The physical layer, the first layer (L1), provides an information transmission service to an upper layer by using a physical channel. The physical layer is connected with a medium access control (MAC) layer located at a higher level through a transport channel, and data between the MAC layer and the physical layer is transferred via the transport channel. Between different physical layers, namely, between physical layers of a transmission side and a reception side, data is transferred via the physical channel.

The MAC layer of Layer 2 (L2) provides services to a radio link control (RLC) layer (which is a higher layer) via a logical channel. The RLC layer of Layer 2 (L2) supports the transmission of data with reliability. It should be noted that the RLC layer illustrated in FIGS. 3(a) and 3(b) is depicted because if the RLC functions are implemented in and performed by the MAC layer, the RLC layer itself is not required. The PDCP layer of Layer 2 (L2) performs a header compression function that reduces unnecessary control information such that data being transmitted by employing Internet protocol (IP) packets, such as IPv4 or IPv6, can be efficiently sent over a radio (wireless) interface that has a relatively small bandwidth.

A radio resource control (RRC) layer located at the lowest portion of the third layer (L3) is only defined in the control plane and controls logical channels, transport channels and the physical channels in relation to the configuration, reconfiguration, and release of the radio bearers (RBs). Here, the RB signifies a service provided by the second layer (L2) for data transmission between the terminal and the UTRAN.

As illustrated in FIG. 3(a), the RLC and MAC layers (terminated in an eNB 20 on the network side) may perform functions such as Scheduling, Automatic Repeat Request (ARQ), and Hybrid Automatic Repeat Request (HARM). The PDCP layer (terminated in eNB 20 on the network side) may perform the user plane functions such as header compression, integrity protection, and ciphering.

As illustrated in FIG. 3(b), the RLC and MAC layers (terminated in an eNodeB 20 on the network side) perform the same functions for the control plane. As illustrated, the RRC layer (terminated in an eNB 20 on the network side) may perform functions such as broadcasting, paging, RRC connection management, Radio Bearer (RB) control, mobility functions, and UE measurement reporting and controlling. The NAS control protocol (terminated in the MME of gateway 30 on the network side) may perform functions such as a SAE bearer management, authentication, LTE_IDLE mobility handling, paging origination in LTE_IDLE, and security control for the signaling between the gateway and UE 10.

The RRC state may be divided into two different states such as a RRC_IDLE and a RRC_CONNECTED. In RRC_IDLE state, the UE 10 may receive broadcasts of system information and paging information while the UE specifies a Discontinuous Reception (DRX) configured by NAS, and the UE has been allocated an identification (ID) which uniquely identifies the UE in a tracking area and may perform PLMN selection and cell re-selection. Also, in RRC-IDLE state, no RRC context is stored in the eNB.

In RRC_CONNECTED state, the UE 10 has an E-UTRAN RRC connection and a context in the E-UTRAN, such that transmitting and/or receiving data to/from the network (eNB) becomes possible. Also, the UE 10 can report channel quality information and feedback information to the eNB.

In RRC_CONNECTED state, the E-UTRAN knows the cell to which the UE 10 belongs. Therefore, the network can transmit and/or receive data to/from UE 10, the network can control mobility (handover and inter-RAT cell change order to GERAN with NACC) of the UE, and the network can perform cell measurements for a neighboring cell.

In RRC_IDLE state, the UE 10 specifies the paging DRX (Discontinuous Reception) cycle. Specifically, the UE 10 monitors a paging signal at a specific paging occasion of every UE specific paging DRX cycle.

The paging occasion is a time interval during which a paging signal is transmitted. The UE 10 has its own paging occasion.

A paging message is transmitted over all cells belonging to the same tracking area. If the UE 10 moves from one tracking area to another tracking area, the UE will send a tracking area update message to the network to update its location.

FIG. 4 is an example of structure of a physical channel. The physical channel transfers signaling and data between layer L1 of a UE and eNB. As illustrated in FIG. 4, the physical channel transfers the signaling and data with a radio resource, which consists of one or more sub-carriers in frequency and one more symbols in time.

One sub-frame, which is 1.0 ms. in length, consists of several symbols. The particular symbol(s) of the sub-frame, such as the first symbol of the sub-frame, can be used for downlink control channel (PDCCH). PDCCHs carry dynamic allocated resources, such as PRBs and MCS.

A transport channel transfers signaling and data between the L1 and MAC layers. A physical channel is mapped to a transport channel.

Downlink transport channel types include a Broadcast Channel (BCH), a Downlink Shared Channel (DL-SCH), a Paging Channel (PCH) and a Multicast Channel (MCH). The BCH is used for transmitting system information. The DL-SCH supports HARQ, dynamic link adaptation by varying the modulation, coding and transmit power, and both dynamic and semi-static resource allocation. The DL-SCH also may enable broadcast in the entire cell and the use of beamforming. The PCH is used for paging a UE. The MCH is used for multicast or broadcast service transmission.

Uplink transport channel types include an Uplink Shared Channel (UL-SCH) and Random Access Channel(s) (RACH). The UL-SCH supports HARQ and dynamic link adaptation by varying the transmit power and potentially modulation and coding. The UL-SCH also may enable the use of beamforming. The RACH is normally used for initial access to a cell.

The MAC sublayer provides data transfer services on logical channels. A set of logical channel types is defined for different data transfer services offered by MAC. Each logical channel type is defined according to the type of information transferred.

Logical channels are generally classified into two groups. The two groups are control channels for the transfer of control plane information and traffic channels for the transfer of user plane information.

Control channels are used for transfer of control plane information only. The control channels provided by MAC include a Broadcast Control Channel (BCCH), a Paging Control Channel (PCCH), a Common Control Channel (CCCH), a Multicast Control Channel (MCCH) and a Dedicated Control Channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by MAC include a Dedicated Traffic Channel (DTCH) and a Multicast Traffic Channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include a DCCH that can be mapped to UL-SCH, a DTCH that can be mapped to UL-SCH and a CCCH that can be mapped to UL-SCH. Downlink connections between logical channels and transport channels include a BCCH that can be mapped to BCH or DL-SCH, a PCCH that can be mapped to PCH, a DCCH that can be mapped to DL-SCH, and a DTCH that can be mapped to DL-SCH, a MCCH that can be mapped to MCH, and a MTCH that can be mapped to MCH.

In E-UTRAN, network-controlled UE-assisted handovers may be performed in RRC-CONNECTED state. The handover procedure is performed without EPC involvement. That is, preparation messages are directly exchanged between the eNBs. The release of the resources at the source side during the handover completion phase is triggered by the eNB.

FIG. 5 is a basic intra-MME/serving gateway handover procedure. It may be referred to paragraph 10.1.2.1.1 of “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 9)” to 3GPP (3rd Generation Partnership Project) TS 36.300 V9.3.0 (2010-03).

First, the handover preparation procedure is described in FIG. 5(a).

In step S50, area restriction information is provided. The UE context within the source eNB contains information regarding roaming restrictions which where provided either at connection establishment or at the last timing advance (TA) update.

In step S51, the source eNB configures the UE measurement procedures according to the area restriction information, and transmits a measurement control message to the UE through L3 signaling. Measurements provided by the source eNB may assist the function controlling the UE's connection mobility. Meanwhile, the packet data is exchanged between the UE and the source eNB, or between the source eNB and the serving gateway.

In step S52, the UE transmits measurement reports by the rules set by i.e. system information, specification etc to the source eNB through L3 signaling.

In step S53, the source eNB makes handover decision based on measurement reports and radio resource management (RRM) information.

In step S54, the source eNB transmits a handover request message through L3 signaling to the target eNB passing necessary information to prepare the HO at the target side. The necessary information may include UE X2 signaling context reference at source eNB, UE S1 EPC signalling context reference, target cell identifier (ID), K_{eNB}*, RRC context including the cell-radio network temporary identifier (C-RNTI) of the UE in the source eNB, AS-configuration, E-UTRAN radio access bearer (E-RAB) context and physical layer ID of the source cell+MAC for possible RLF recovery, etc. UE X2/UE S1 signaling references enable the target eNB to address the source eNB and the EPC. The E-RAB context includes necessary radio network layer (RNL) and transport network layer (TNL) addressing information, and quality of service (QoS) profiles of the E-RABs.

In step S55, the target eNB performs admission control. Admission control may be performed dependent on the received E-RAB QoS information to increase the likelihood of a successful HO, if the resources can be granted by target eNB. The target eNB configures the required resources according to the received E-RAB QoS information and reserves a C-RNTI and optionally a RACH preamble. The AS-configuration to be used in the target cell can either be specified independently (i.e. an “establishment”) or as a delta compared to the AS-configuration used in the source cell (i.e. a “reconfiguration”).

In steps S56, the target eNB transmits a handover request acknowledge message to the source eNB through L3 signaling, and prepares the handover. The handover request acknowledge message may include a transparent container to be sent to the UE as an RRC message to perform the handover. The transparent container may include a new C-RNTI, target eNB security algorithm identifiers for the selected security algorithms, a dedicated RACH preamble, and possibly some other parameters i.e. access parameters, SIBs, etc. The handover request acknowledge message may also include RNL/TNL information for the forwarding tunnels, if necessary. Meanwhile, as soon as the source eNB receives the handover request acknowledge message, or as soon as the transmission of the handover command is initiated in the downlink, data forwarding may be initiated.

In step S57, the target eNB transmits an RRCConnectionReconfiguration message to perform the handover including the mobilityControlInformation, to be sent by the source eNB to the UE. The source eNB performs the necessary integrity protection and ciphering of the message. The UE receives the RRCConnectionReconfiguration message with necessary parameters. The necessary parameters may include new C-RNTI, target eNB security algorithm identifiers, and optionally dedicated RACH preamble, target eNB SIBs, etc. The UE is commanded by the source eNB to perform the handover. The UE does not need to delay the handover execution for delivering the HARQ/ARQ responses to the source eNB.

Hereafter, the handover execution procedure will be described.

When the handover execution procedure starts, the UE detaches from old cell and synchronizes to new cell. In addition, the source eNB delivers buffered and in-transit packets to the target eNB.

In step S58, the source eNB transmits an SN status transfer message to the target eNB to convey the uplink PDCP SN receiver status and the downlink PDCP SN transmitter status of E-RABs for which PDCP status preservation applies (i.e. for RLC AM). The uplink PDCP SN receiver status may include at least the PDCP SN of the first missing UL SDU and a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.

FIG. 5(b) is continued from FIG. 5(a).

In step S59, the UE performs synchronization to the target eNB and access the target cell via RACH. The access to the target cell via RACH may be a contention-free procedure if a dedicated RACH preamble was indicated in the mobilityControlInformation. Or, the access to the target cell via RACH may be a contention-based procedure if no dedicated preamble was indicated. The UE derives target eNB specific keys and configures the selected security algorithms to be used in the target cell.

In step S60, the target eNB responds to the synchronization of the UE with UL allocation and timing advance.

In step S61, when the UE has successfully accessed the target cell, the UE transmits an RRCConnectionReconfigurationComplete message (C-RNTI) to confirm the handover, along with an uplink buffer status report, whenever possible, to the target eNB to indicate that the handover procedure is completed for the UE. The target eNB verifies the C-RNTI sent in the RRCConnectionReconfigurationComplete message. The target eNB can now begin transmitting data to the UE. The packet data is exchanged between the UE and the target eNB.

Hereafter, the handover completion procedure will be described.

In step S62, the target eNB transmits a path switch message to MME to inform that the UE has changed cell.

In step S63, the MME transmits an update user plane request message to the serving gateway.

In step S64, the serving gateway switches the downlink data path to the target side. The serving gateway transmits one or more end marker packets on the old path to the source eNB and then can release any U-plane/TNL resources towards the source eNB.

In step S65, serving gateway transmits an update user plane response message to MME.

In step S66, the MME transmits a path switch acknowledge message to the target eNB to confirm the path switch message.

In step S67, the target eNB transmits a UE context release message to the source eNB to inform success of the handover and trigger the release of resources.

In step S68, when the UE context release message is received, the source eNB can release radio and C-plane related resources associated to the UE context. Any ongoing data forwarding may continue.

Meanwhile, a wireless communication system including a relay station (RS) has been developed recently. The relay station serves to expand cell coverage and improve transmission performance. The cell coverage may be expanded as a base station provides service to a mobile station located at the coverage boundary of the base station by using a relay station. Furthermore, since the relay station enhances the reliability of signal transmission between the base station and the mobile station, transmission capacity can be increased. Even when a mobile station is within the coverage of the base station, the relay station may be used in the case where the mobile station is located in a shadow zone.

LTE-advance (LTE-A) is an evolution of the 3GPP LTE. The relay system can be introduced in LTE-A. According to the introduction of the relay system, a conventional handover procedure described above can be changed. A relay node forwards the data packets from the UE to the eNB, or the relay node forwards the data packets from the eNB to the UE. Accordingly, the packets back and forth forwarding problem can be happened in the handover procedure.

An efficient handover method when a relay node is deployed is required.

### SUMMARY OF INVENTION

### Technical Problem

The present invention provides a method and apparatus for performing a handover procedure in a wireless communication system. In addition, the present invention solves the packets back and forth forwarding problem, i.e., the radio resource waste, of the Un interface in LTE-A (Long-Term Evolution Advanced) relay system when a user equipment (UE) served by relay node requests handover to another evolved NodeB (eNB) or relay node.

### Solution to Problem

In an aspect, a method of performing a handover procedure by a donor base station

(BS) in a wireless communication system is provided. The method include receiving a handover request message from a relay node (RN), transmitting an end marker to the RN, buffering downlink (DL) data packets, transmitting a handover request acknowledgement message to the RN if the handover request message is acknowledged, and forwarding the buffered DL data packets to a target BS.

The RN may be served by the donor BS through an Un interface.

The method may further include reordering the buffered DL data packets and at least one data packet transmitted to the RN before the reception of the handover request message.

The at least one data packet may be forwarded to the target BS.

The method may further include forwarding the handover request message to the target BS.

The handover request message may be received through an Un interface.

The handover request acknowledgement message may be transmitted through the Un interface.

The method may further include receiving a sequence number (SN) status transfer message from the RN.

The method may further include forwarding the SN status transfer message to the target BS.

In another aspect, a method of performing a handover procedure by a relay node (RN) in a wireless communication system is provided. The method include transmitting a handover request message to a base station (BS), receiving an end marker from the BS before receiving a handover request acknowledgement message corresponding to the handover request message, receiving the handover request acknowledgement message from the BS.

The RN may be served by the BS through an Un interface.

The handover request message may be transmitted through an Un interface.

The handover request acknowledgement message may be received through the Un interface.

The method may further include transmitting a sequence number (SN) status transfer message to the BS.

The method may further include transmitting a handover command message to a user equipment for a handover.

### Advantageous Effects of Invention

The limited radio resource of Un interface can be saved because data packet back and forth forwarding problem is reduced.

### BRIEF DESCRIPTION OF DRAWINGS

FIG. 1 is a block diagram illustrating network structure of an evolved universal mobile telecommunication system (E-UMTS).

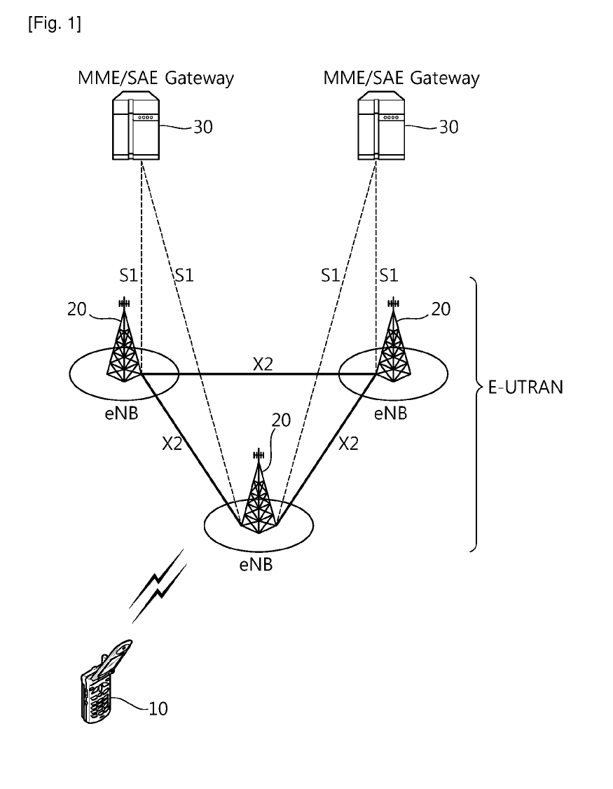

FIG. 2 is a block diagram depicting architecture of a typical E-UTRAN and a typical EPC.

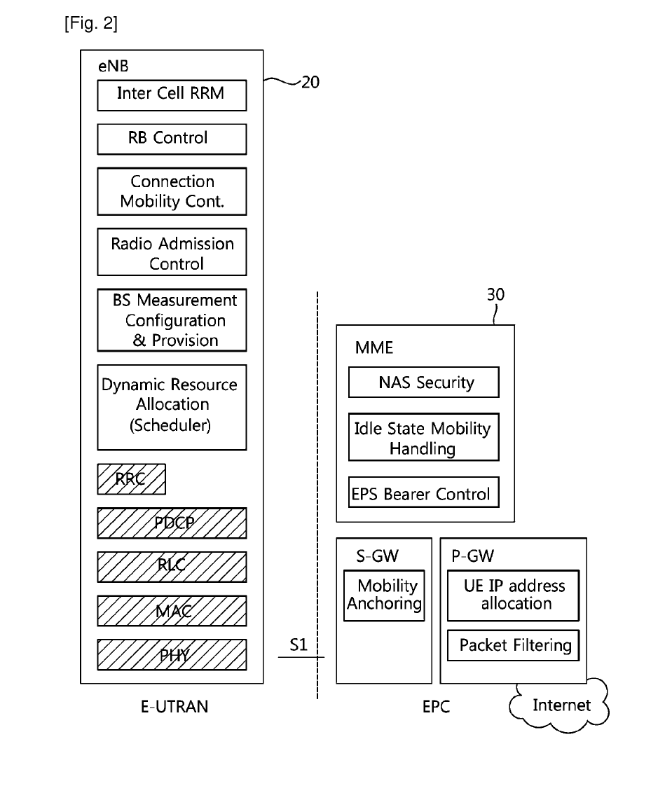

FIG. 3 is block diagram depicting the user-plane protocol and the control-plane protocol stack for the E-UMTS.

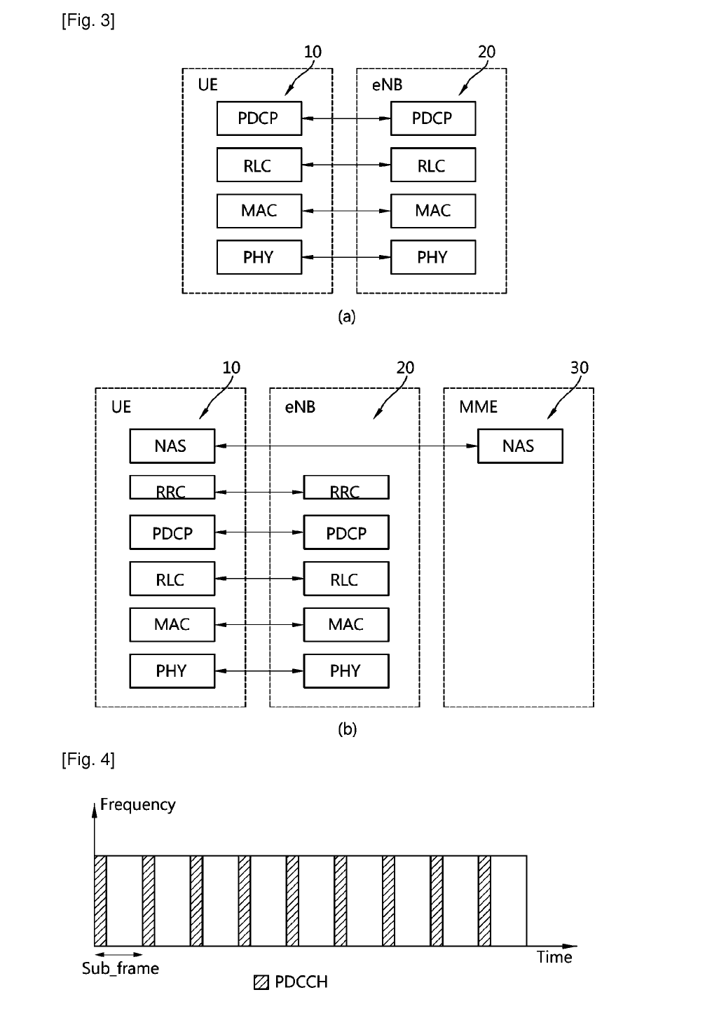

FIG. 4 is an example of structure of a physical channel. The physical channel transfers signaling and data between layer L1 of a UE and eNB.

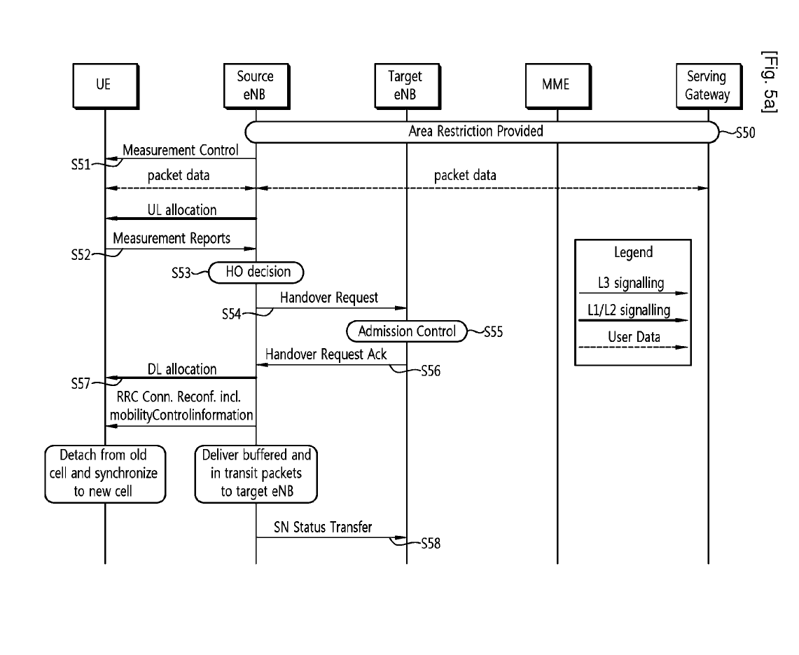

FIG. 5 is a basic intra-MME/serving gateway handover procedure.

FIG. 6 a block diagram illustrating network structure of an LTE-A system introducing a relay system.

FIG. 7 is an intra-MME/serving gateway handover procedure when a relay node is adopted.

FIG. 8 is a simplified handover procedure when a relay node is adopted.

FIG. 9 is a simplified handover procedure according to an embodiment of the proposed method.

FIG. 10 is a block diagram showing wireless communication system to implement an embodiment of the present invention.

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

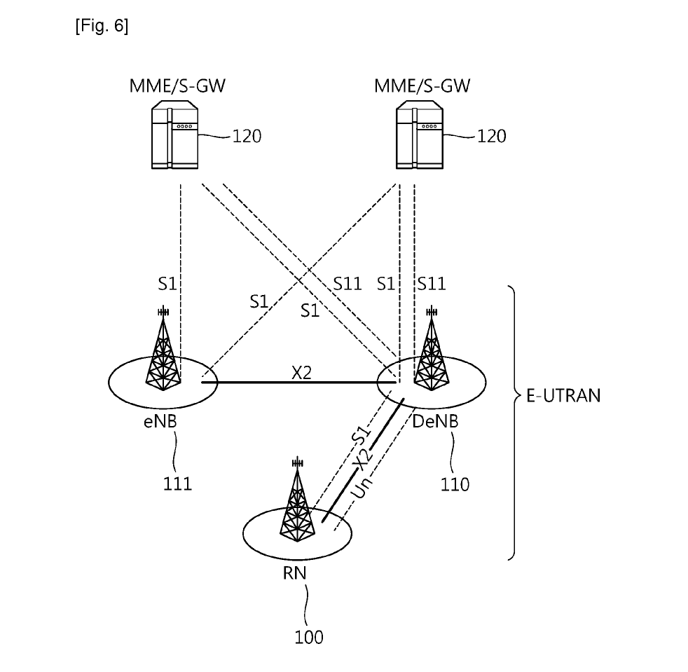

FIG. 6 a block diagram illustrating network structure of an LTE-A system introducing a relay system.

Referring to FIG. 6, the LTE-A network includes an evolved UMTS terrestrial radio access network (E-UTRAN), an Evolved Packet Core (EPC) and one or more user equipment (not described). The E-UTRAN may include one or more evolved NodeB (eNB) 111, one or more donor eNB (DeNB) 110, one or more relay node (RN) 100 and a plurality of user equipment (UE) 10 may be located in one cell. One or more E-UTRAN mobility management entity (MME)/system architecture evolution (SAE) gateways 120 may be positioned at the end of the network and connected to an external network.

As used herein, “downlink” refers to communication from the eNB 111 to the UE, from the DeNB 110 to the UE or from the RN 100 to the UE, “uplink” refers to communication from the UE to the eNB 111, from the UE to the DeNB 110 or from the UE to the RN 100. The UE refers to communication equipment carried by a user and may be also referred to as a mobile station (MS), a user terminal (UT), a subscriber station (SS) or a wireless device.

The eNB 111 and the DeNB 110 provide end points of a user plane and a control plane to the UE. MME/SAE gateway 120 provides an end point of a session and mobility management function for UE. The eNB 111 and MME/SAE gateway 120 may be connected via an S1 interface. The DeNB 110 and MME/SAE gateway 120 may be connected via an S1 interface. The eNBs 111 may be connected to each other via an X2 interface and neighboring eNBs may have a meshed network structure that has the X2 interface. The eNB 111 and the DeNB 110 may be connected to each other via an X2 interface

The RN 100 is wirelessly connected to the DeNB 110 via a modified version of the E-UTRA radio interface being called the Un interface. That is, the RN 100 may be served by the DeNB 110. The RN 100 supports the eNB functionality which means that it terminates the S1 and X2 interfaces. Functionality defined for the eNB 111 or the DeNB 110, e.g. radio network layer (RNL) and transport network layer (TNL), also applies to RNs 100 unless explicitly specified. In addition to the eNB functionality, the RN 100 also supports a subset of the UE functionality, e.g. physical layer, layer-2, radio resource control (RRC), and non-access stratum (NAS) functionality, in order to wirelessly connect to the DeNB.

The RN 100 terminates the S1, X2 and Un interfaces. The DeNB 110 provides S1 and X2 proxy functionality between the RN 100 and other network nodes (other eNBs, MMEs and S GWs). The S1 and X2 proxy functionality includes passing UE-dedicated S1 and X2 signaling messages as well as GTP data packets between the S1 and X2 interfaces associated with the RN 100 and the S1 and X2 interfaces associated with other network nodes. Due to the proxy functionality, the DeNB 110 appears as an MME (for S1) and an eNB (for X2) to the RN. The DeNB 110 also embeds and provides the SGW/P-GW-like functions needed for the RN operation. This includes creating a session for the RN 100 and managing EPS bearers for the RN 100, as well as terminating the S11 interface towards the MME serving the RN 100.

Among the hot issues of relay, handover is an important one du to the addition of Un interface.

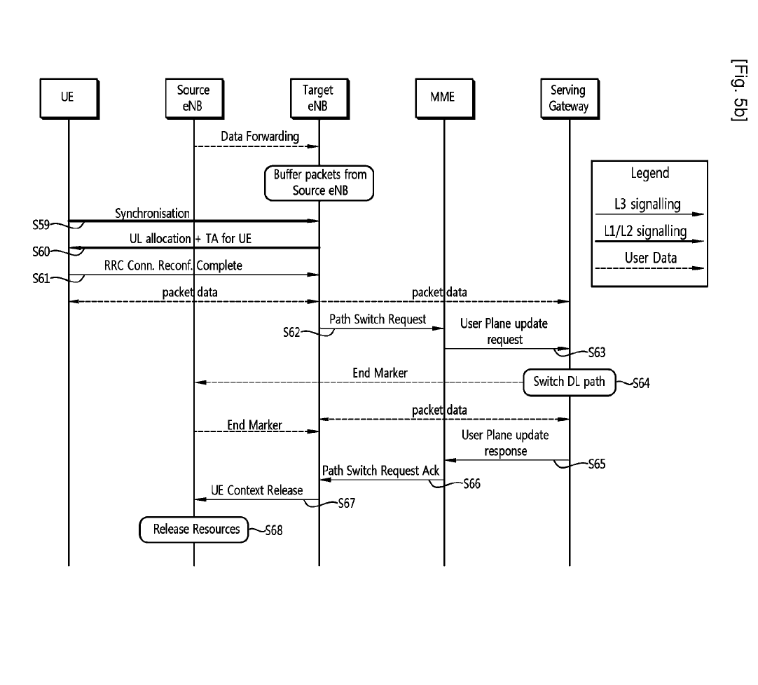

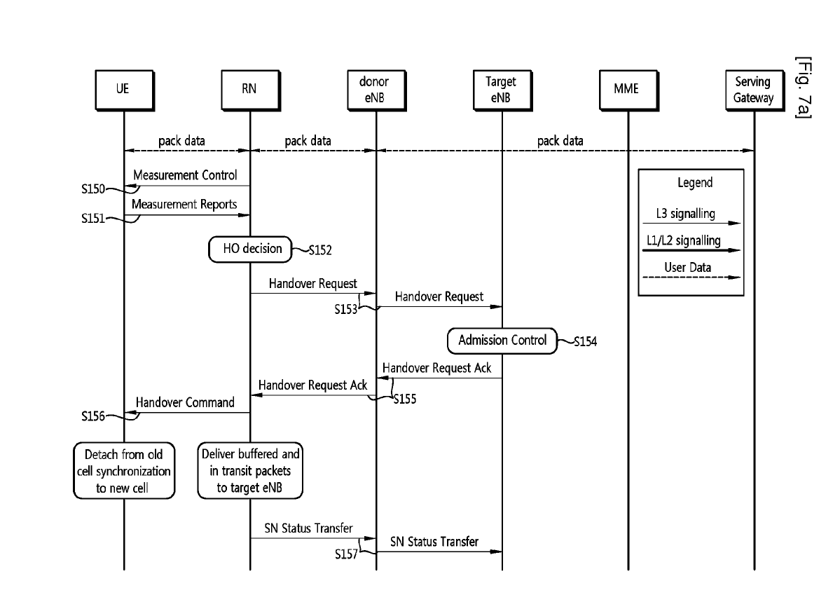

FIG. 7 is an intra-MME/serving gateway handover procedure when a relay node is adopted. The handover procedure in FIG. 7 is similar to the handover procedure in FIG. 5. Unlike FIG. 5, a relay node (RN) and a donor eNB (DeNB) is included in FIG. 7. The DeNB in FIG. 7 performs the same function as the source eNB in FIG. 5. The RN is served by the DeNB.

First, the handover preparation procedure is described in FIG. 7(a).

In step S150, the RN configures the UE measurement procedures according to area restriction information, and transmits a measurement control message to the UE through L3 signaling. Measurements provided by the RN may assist the function controlling the UE's connection mobility. Meanwhile, the packet data is exchanged between the UE and the RN, between the RN and the DeNB, or between the DeNB and the serving gateway.

In step S151, the UE transmits measurement reports by the rules set by i.e. system information, specification etc to the RN through L3 signaling.

In step S152, the RN makes handover decision based on measurement reports and radio resource management (RRM) information.

In step S153, the RN transmits a handover request message through L3 signaling to the DeNB passing necessary information to prepare the HO at the target side. The DeNB delivers the handover request message through L3 signaling to the target eNB.

In step S154, the target eNB performs admission control. Admission control may be performed dependent on the received E-RAB QoS information to increase the likelihood of a successful HO, if the resources can be granted by the target eNB. The target eNB configures the required resources according to the received E-RAB QoS information and reserves a C-RNTI and optionally a RACH preamble. The AS-configuration to be used in the target cell can either be specified independently (i.e. an “establishment”) or as a delta compared to the AS-configuration used in the source cell (i.e. a “reconfiguration”).

In steps S155, the target eNB transmits a handover request acknowledge message to the deNB through L3 signaling, and prepares the handover. The DeNB delivers the handover request acknowledge message to the RN. The handover request acknowledge message may include a transparent container to be sent to the UE as an RRC message to perform the handover. The transparent container may include a new C-RNTI, target eNB security algorithm identifiers for the selected security algorithms, a dedicated RACH preamble, and possibly some other parameters i.e. access parameters, SIBs, etc. The handover request acknowledge message may also include RNL/TNL information for the forwarding tunnels, if necessary. Meanwhile, as soon as the RN receives the handover request acknowledge message, or as soon as the transmission of the handover command is initiated in the downlink, data forwarding may be initiated.

In step S156, the RN transmits a handover command message to the UE to perform the handover. The UE receives the handover command message with necessary parameters. The necessary parameters may include new C-RNTI, target eNB security algorithm identifiers, and optionally dedicated RACH preamble, target eNB SIBs, etc. The UE is commanded by the RN to perform the handover.

Hereafter, the handover execution procedure will be described.

When the handover execution procedure starts, the UE detaches from an old cell and synchronizes to a new cell. In addition, the RN delivers buffered and in-transit packets to the target eNB.

In step S157, the RN transmits an SN status transfer message to the DeNB to convey the uplink PDCP SN receiver status and the downlink PDCP SN transmitter status of E-RABs for which PDCP status preservation applies (i.e. for RLC AM). The DeNB delivers the SN status transfer message to the target eNB. The uplink PDCP SN receiver status may include at least the PDCP SN of the first missing UL SDU and a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The RN may omit sending this message if none of the E-RABs of the UE shall be treated with PDCP status preservation.

FIG. 7(b) is continued from FIG. 7(a).

In step S158, the UE performs synchronization to the target eNB and access the target cell via RACH. The access to the target cell via RACH may be a contention-free procedure if a dedicated RACH preamble was indicated in the mobilityControlInformation. Or, the access to the target cell via RACH may be a contention-based procedure if no dedicated preamble was indicated. The UE derives target eNB specific keys and configures the selected security algorithms to be used in the target cell.

In step S159, the target eNB responds to the synchronization of the UE with UL allocation and timing advance.

In step S160, when the UE has successfully accessed the target cell, the UE transmits an RRCConnectionReconfigurationComplete message (C-RNTI) to confirm the handover, along with an uplink buffer status report, whenever possible, to the target eNB to indicate that the handover procedure is completed for the UE. The target eNB verifies the C-RNTI sent in the RRCConnectionReconfigurationComplete message. The target eNB can now begin transmitting data to the UE. The packet data is exchanged between the UE and the target eNB.

Hereafter, the handover completion procedure will be described.

In step S161, the target eNB transmits a path switch message to MME to inform that the UE has changed cell.

In step S162, the MME transmits an update user plane request message to the serving gateway.

In step S163, the serving gateway switches the downlink data path to the target side. The serving gateway transmits one or more end marker packets on the old path to the source eNB and then can release any U-plane/TNL resources towards the source eNB.

In step S164, serving gateway transmits an update user plane response message to MME.

In step S165 the MME transmits a path switch acknowledge message to the target eNB to confirm the path switch message.

In step S166, the target eNB transmits a UE context release message to the DeNB to inform success of the handover and trigger the release of resources. The DeNB delivers the UE context release message to the RN.

In step S167, the RN flushes DL buffer, and continues delivering in-transit packets.

In step S168, when the UE context release message is received, the RN can release radio and C-plane related resources associated to the UE context. Any ongoing data forwarding may continue.

In the handover procedure when relay is adopted, the packets back and forth forwarding problem in the Un interface can be happened. Packets may be delivered from the UE to the RN, and from the RN to the eNB. Or, packets may be delivered from the eNB to the RN, and from the RN to the UE. Accordingly, there are mainly two problems introduced by the unnecessary back and forth forwarding of packets.

1) Increased Data Latency

During the handover, the redundant 2-hop transmissions of user data (from RN to eNB and from RN to eNB) could incur user plane latency of about 10 ms. For example, the packet data is forwarded from the RN to the DeNB, and from the DeNB to the target eNB in FIG. 7. Also, the end marker received from the serving gateway is delivered from the RN to the DeNB, and from the Denb to the target eNB. Accordingly, because of introduction of the RN, unnecessary latency can be occurred. When considering other latencies, e.g. scheduling, the total latency could potentially be even higher.

2) Wasted Radio Resources

Referring to FIG. 7, the wireless transmission loop (eNB-RN-eNB) is established since the UE detaches from old cell until the end marker command from the serving gateway arrives at the RN. For each UE detached from the RN, the wasted radio resources would be the downlink and uplink resources to forward the amount of UE DL data during that period. As the RN generally covers relatively small coverage area, and the handover may be rather frequent, thus problem of the wasted radio resources may be more severe.

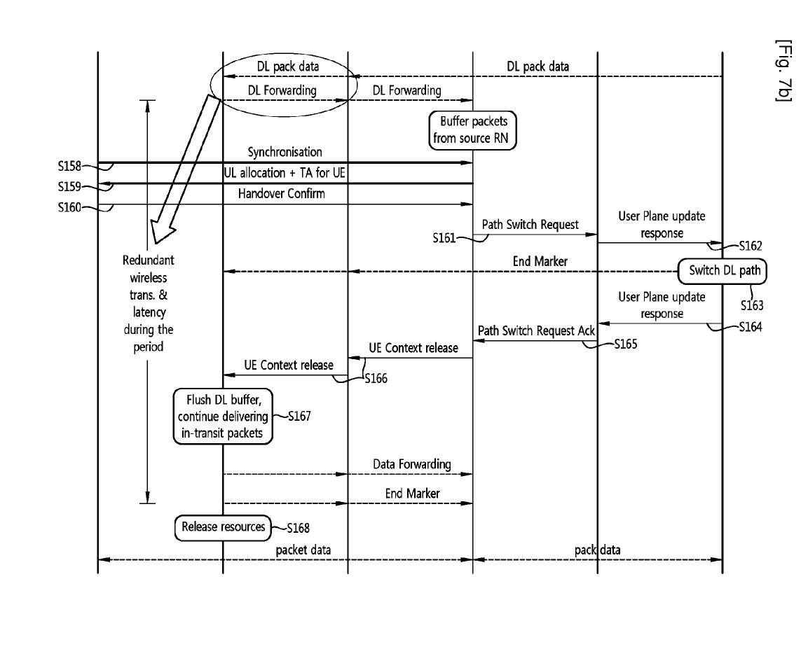

FIG. 8 is a simplified handover procedure when a relay node is adopted. From step S153 to step to S157 of the handover procedure in FIG. 7 can be replaced with the simplified handover procedure described in FIG. 8. To solve the problem mention above, a method of keeping the DL transmission to the RN even after the handover request message arrives can be proposed.

In step S200, the RN transmits a handover request message to the DeNB.

In step S210, the DeNB decides the timing and transmits start marker packets to the RN. Since the start marker packets are transmitted, the DL data packets buffering starts. Both the DeNB and RN can synchronize the UE DL data packets after the start marker packets by setting the packet following the start maker packets as the first packet.

In step S220, the DeNB transmits a handover request acknowledgment message to the RN.

In step S230, the RN transmits a handover command message to the UE. When the UE receives the handover command message from the RN, the UE detaches from an old cell and synchronizes to a new cell.

In step S240, the RN transmits an SN status transfer message to the DeNB.

In step S250, once the UE detaches from the old cell, the RN transmits a status report message to the DeNB to inform that which UE DL data packets has been successfully acknowledged and which was not. The status report message corresponds to the start marker packets. Those non-acknowledged data packets would be directly selected from the DeNB buffer and forwarded to the target eNB. Therefore transmission of these RN buffered data from RN to DeNB on the Un interface is not needed any more.

However, in the simplified handover procedure above, additional start marker packets is necessary for deciding the timing of DeNB's DL data packets buffering. Also, a detailed status report message corresponding to these buffering data packets is necessary. Accordingly, a signaling overhead can be happened. The other drawback is the Un radio resource waste because of the keeping DL packets transmission and status report feedback message.

Therefore, an efficient handover method which can solve the problem mentioned above may be required.

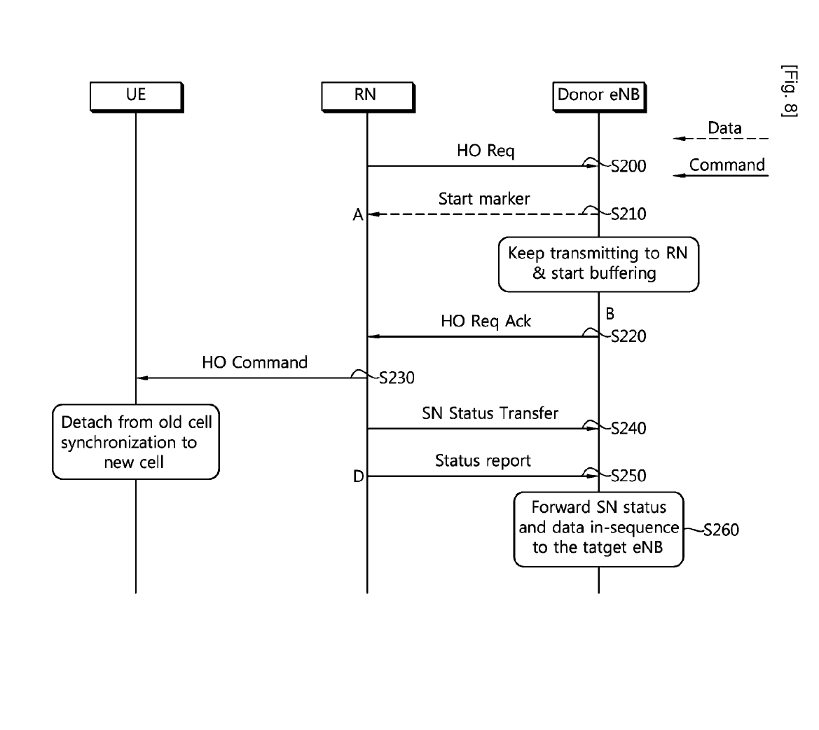

FIG. 9 is a simplified handover procedure according to an embodiment of the proposed method. From step S153 to step to S157 of the handover procedure in FIG. 7 can be replaced with the simplified handover procedure described in FIG. 9.

Referring to FIG. 9, in step S300, the RN transmits a handover request message to the DeNB. When the DeNB receives the handover request message, the DeNB immediately terminates data packets transmission to the RN.

In step S310, the DeNB transmits an end marker to the RN. Since the end marker is transmitted, DeNB also starts to buffer the DL data packets corresponding to the UE.

Referring to FIG. 7, the end marker is used for assisting the reordering function in the target eNB. The serving gateway transmits one or more end marker on the old path immediately after switching the path for each E-RAB of the UE. After transmitting the end marker, the serving gateway shall not transmits any further user data packets via the old path. In other words, the end marker is the last data packets transmitted through the old path. If the RN is introduced, the end marker may be forwarded from the DeNB to the RN. In the proposed simplified handover procedure, the end marker is transmitted before the DeNB receiving the end marker from the serving gateway in order to solve the data packet back and forth forwarding problem. Therefore, the proposed scheme is not complicated comparing with the legacy scheme.

Referring to FIG. 9 again, in step S320, when the handover is acknowledged, the DeNB transmits a handover request acknowledgement message to the RN.

In step S330, the RN transmits a handover command message to the UE. When the UE receives the handover command message from the RN, the UE detaches from an old cell and synchronizes to a new cell.

In step S340, the RN transmits an SN status transfer message to the DeNB.

In step S350, when the end marker comes back to the DeNB, the DeNB reorders the forwarded data packets sent before the handover request is transmitted and the buffered data packets, and then transmits them to the target eNB in sequence.

Using the end marker, the amount of data packets forwarded back and forth between the RN and the DeNB can be reduced as more as possible. That is because DeNB starts to buffer the data packets in a relatively early stage.

The simplified handover procedure of the proposed method has two advantages. At first, the radio resource of Un interface can be saved. Second, a start marker and a status report message for Un interface are not necessary, which may reduce the complexity of system. The disadvantage of the proposed scheme is that delay may happen to the UE since DeNB stops the transmission of DL data packets to the UE in an early stage. In fact the UE is not sensitive to it because the data rate of cell edge UE is very low. If the handover request message is not acknowledged or the UE returns to the DeNB again, the DeNB may restart the transmission to the UE again.

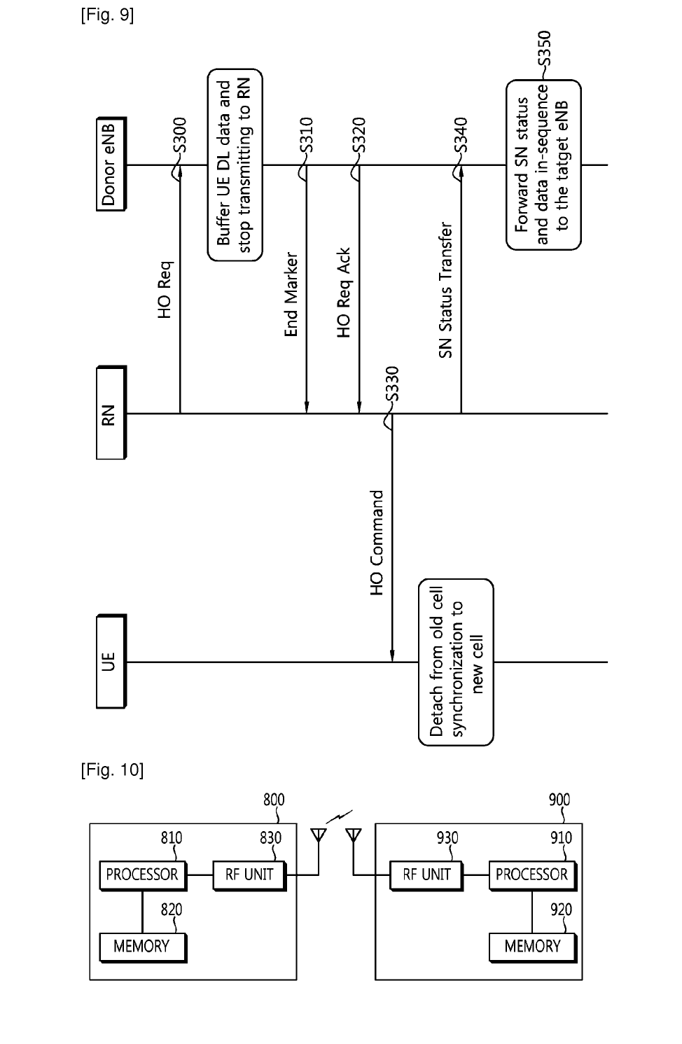

FIG. 10 is a block diagram showing wireless communication system to implement an embodiment of the present invention.

A BS 800 includes a processor 810, a memory 820, and an RF (Radio Frequency) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An RN 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processor 910 may include an application-specific integrated circuit (ASIC), another chip set, a logical circuit, and/or a data processing unit. The RF unit 920 may include a baseband circuit for processing radio signals. In software implemented, the aforementioned methods can be implemented with a module (i.e., process, function, etc.) for performing the aforementioned functions. The module may be performed by the processor 910.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the spirit and scope of the appended claims.

1. A method of performing a handover procedure by a donor base station (BS) in a wireless communication system, the method comprising:
receiving a handover request message from a relay node (RN);
transmitting an end marker to the RN;
buffering downlink (DL) data packets;
transmitting a handover request acknowledgement message to the RN if the handover request message is acknowledged; and
forwarding the buffered DL data packets to a target BS.

2. The method of claim 1, wherein the RN is served by the donor BS through an Un interface.

3. The method of claim 1, further comprising:
reordering the buffered DL data packets and at least one data packet transmitted to the RN before the reception of the handover request message.

4. The method of claim 3, wherein the at least one data packet is forwarded to the target BS.

5. The method of claim 1, further comprising:
forwarding the handover request message to the target BS.

6. The method of claim 1, wherein the handover request message is received through an Un interface.

7. The method of claim 6, wherein the handover request acknowledgement message is transmitted through the Un interface.

8. The method of claim 1, further comprising:
receiving a sequence number (SN) status transfer message from the RN.

9. The method of claim 8, further comprising:
forwarding the SN status transfer message to the target BS.

10. A method of performing a handover procedure by a relay node (RN) in a wireless communication system, the method comprising:
transmitting a handover request message to a base station (BS);
receiving an end marker from the BS before receiving a handover request acknowledgement message corresponding to the handover request message;
receiving the handover request acknowledgement message from the BS.

11. The method of claim 10, wherein the RN is served by the BS through an Un interface.

12. The method of claim 10, wherein the handover request message is transmitted through an Un interface.

13. The method of claim 12, wherein the handover request acknowledgement message is received through the Un interface.

14. The method of claim 10, further comprising:
transmitting a sequence number (SN) status transfer message to the BS.

15. The method of claim 10, further comprising:
transmitting a handover command message to a user equipment for a handover.
